(19) United States
(12) Patent Application Publication
(10) Pub. No.: US 2021/0057912 A1
(43) Pub. Date: Feb. 25, 2021

(54) ELECTROMECHANICAL TRANSIENT SIMULATION METHOD FOR POWER SYSTEM BASED ON DIRECT LINEAR ALGORITHM

(71) Applicant: Hongwei DENG, Chengdu (CN)

(72) Inventors: Hongwei DENG, Chengdu (CN); Chaoyin Deng, Chengdu (CN)

(73) Assignee: Hongwei DENG, Chengdu (CN)

(21) Appl. No.: 16/969,583

(22) PCT Filed: Mar. 12, 2019
(86) PCT No.: PCT/CN2019/077729

§ 371 Date: Aug. 13, 2020

(30) Foreign Application Priority Data
Mar. 16, 2018 (CN) 201810219284.1

(51) Int. Cl. H02J 3/38; H02J 3/18; G06F 30/20

(52) U.S. Cl. CPC H02J 3/38; H02J 3/18; G06F 2111/10; H02J 2203/20; G06F 30/20

(57) ABSTRACT

An electromechanical transient simulation method for a power system based on a direct linear algorithm includes the following steps: A. initializing power system parameters; B. using the direct linear algorithm to calculate a power flow distribution of the power system; C. calculating an angular acceleration, an angular velocity, a rotor angle and a frequency of each generator in the next frame; D. performing frequency adjustment; E. performing excitation adjustment; F. calculating a rotary electromotive force of a generator according to the rotor angle and frequency of the generator in the next frame; G. calculating an average frequency f_{W,n+1} of the entire grid according to the frequency f_{i,n+1} of each generator; H. bringing the average frequency f_{W,n+1} to each node and calculating its corresponding reactance and susceptance, substituting the rotary electromotive force into a corresponding generator, and finally calculating a new matrix of all the nodes; and I. returning to step B.

### CROSS REFERENCE TO THE RELATED APPLICATIONS

This application is the national phase entry of International Application No. PCT/CN2019/077729, filed on Mar. 12, 2019, which is based upon and claims priority to Chinese Patent Application No. 201810219284.1, filed on Mar. 16, 2018, the entire contents of which are incorporated herein by reference.

### TECHNICAL FIELD

The present invention belongs to the technical field of power system simulation, and particularly relates to an electromechanical transient simulation method for a power system based on a direct linear algorithm.

### BACKGROUND

Electromechanical transient simulation for power systems is a very important analysis method for the power systems. For a power system in operation, the electromechanical transient simulation can predict whether large disturbances (such as short-circuit faults, removal of circuits, generators, loads, generator adjustment excitation, shock loads, and transformer gear adjustment, etc.) will endanger the safety of the power system, whether the voltages of all busbars in the system are within an allowable range, whether various components (such as circuits, transformers, etc.) in the system will be overloaded, and what precautions should be taken in advance when an overload occurs. For a planned power system, the electromechanical transient simulation can verify whether the proposed power system planning scheme can meet the requirements of various operation modes.

The traditional electromechanical transient simulation algorithms for the power system are to solve a system of differential equations and a system of algebraic equations in the power system simultaneously to obtain time domain solutions of physical quantities. The methods of solving the differential equations mainly include an implicit trapezoidal integral method, an improved Euler method and a Runge-Kutta method. The method of solving the algebraic equations mainly adopts a Newton method suitable for solving nonlinear algebraic equations, namely an iterative method.

The traditional electromechanical transient simulation methods have the following shortcomings: the calculation results are highly erroneous, low-accuracy and non-convergent, and the calculation speed is slow. Moreover, the traditional electromechanical transient simulation method is established on the basis that the frequency of all generators is synchronized and consistent, which is inconsistent with the actual situation of the power grid. It is difficult to reflect the real changes in the power grid.

### SUMMARY

In order to solve the above problems in the prior art, an objective of the present invention is to provide an electromechanical transient simulation method for a power system based on a direct linear algorithm, which overcomes the shortcomings of the traditional simulation methods. The electromechanical transient simulation method of the present invention has no iteration and has a fast calculation speed, a high precision and a small error, and truly reflects the changing characteristics of the power grid. For example, the impedance of each circuit, load and transformer changes with the frequency change of the power grid, and the frequency of each generator in the power grid can also dynamically change according to its own law.

The technical solution adopted by the present invention is as follows: an electromechanical transient simulation method for a power system based on a direct linear algorithm, including the following steps:
A. initializing power system parameters and calculating an initial matrix of each node in the power system;
B. using the direct linear algorithm to calculate a power flow distribution of the power system, wherein an output active power of an i-th node generator in a n-th frame is P_{i,n}, an output reactive power is Q_{i,n}, a terminal voltage of the generator is U_{i,n} and a power factor is COS_{i,n};
C. performing frequency adjustment to adjust a kinetic moment T_{i,n+1} of the i-th node generator in a (n+1)-th frame;
D. performing excitation adjustment to adjust an excitation current I_{Li,n+1} of the i-th node generator in the (n+1)-th frame;
E. calculating an angular acceleration a_{ω}_{_{i,n+1}}, an angular velocity ω_{i,n+1}, a rotor angle θ_{i,n+1} and a frequency f_{i,n+1} of the i-th node generator in the (n+1)-th frame:

$$\{ \begin{matrix}{a}_{{ω}_{i , n + 1}} = \frac{{T}_{i , n + 1} - \frac{{P}_{i , n}}{{ω}_{i , n}}}{{J}_{i}} \\ {ω}_{i , n + 1} = {ω}_{i , n} + {a}_{{ω}_{i , n + 1}} \times Δ T \\ {θ}_{i , n + 1} = {θ}_{i , n} + {ω}_{i , n + 1} \times Δ T \\ {f}_{i , n + 1} = \frac{{ω}_{i , n + 1}}{2 π}\end{matrix}$$

wherein Jᵢ is a rotating inertia of the i-th node generator, ΔT is a frame calculation time interval, n is a frame number, and an initial value of n is 0;
F. according to the rotor angle θ_{i,n+1}, the frequency f_{i,n+1} and the excitation current I_{Li,n+1} of the generator in the (n+1)-th frame, calculating a rotating electromotive force of the generator in the (n+1)-th frame, wherein
an absolute value of the rotating electromotive force of the generator is |E_{i,n+1}|=K_{Li}×I_{Li,n+1}×f_{i,n+1}, and a vector value of the rotating electromotive force is Ė_{i,n+1}=|E_{i,n+1}|×e^{θ}^{_{i,n+1}}, where K_{Li} is an electromotive force coefficient of the i-th node generator;
G. replacing a frequency of the power grid in the (n+1)-th frame with an average frequency

$${f}_{W , n + 1} = \frac{1}{m} \sum {f}_{i , n + 1}$$

of all generators on the power grid in the (n+1)-th frame, where m is a total number of generators in the power system;
H. calculating reactance and susceptance of each node according to f_{W,n+1}, bringing Ė_{i,n+1} and the calculated reactance and susceptance of each node into the initial matrix of each node, and finally calculating a new matrix of each node; and
I. returning to step B.

Further, the step of initializing the power system parameters in the step A specifically includes the following processes:
A1. setting the frame calculation time interval ΔT;
A2. setting an initial frequency f_{i,0}=50 Hz, an initial angular acceleration a_{ω}_{_{i,0}}=0, an initial angle θ_{i,0}=0, and an initial angular velocity ω_{i,0}=2×π×f_{i,0} of each generator;
A3. setting the excitation current I_{Li,0} of each generator to a rated value and setting an excitation coefficient K_{Li} of each generator, wherein an initial value of the rotating electromotive force of each generator is Ė_{i,0}=K_{Li}×I_{Li,0}×f_{i,0}×e^{j0};
A4. setting an initial value of a system frequency on the grid to f_{W,0}=50 Hz, determining the reactance and susceptance of each node according to f_{W,0}, and finally calculating the initial matrices of all nodes;
A5. setting a kinetic moment of a grid-connected generator, or sharing a load of the whole grid according to a capacity ratio of the grid-connected generator, and determining the kinetic moment

$${T}_{i , 1} = {T}_{i , 0} = \frac{{P}_{i , 0}}{{ω}_{i , 0}}$$

of each generator in a first frame and a starting frame;
A6. setting a frequency modulation coefficient K_{Ti} and a dead zone frequency Δf_{sqi} of a frequency modulation generator;
A7. setting a voltage adjustment coefficient Kᵤᵢ, a set voltage U_{sdi} and a dead zone voltage ΔU_{sqi} of a voltage adjustment generator;
A8. setting a reactive power adjustment coefficient K_{Qi}, a set reactive power Q_{sdi} and a dead zone reactive power ΔQ_{sqi} of a reactive power generator; and
A9. setting a power factor adjustment coefficient Kₑₒₛᵢ, a set power factor COS_{sdi} and a dead zone power factor ΔCOS_{sqi} of a power factor adjustment generator.

Further, the step A4 specifically includes the following processes: assuming that in the power system, at an initial frequency f_{W,0}=50 Hz, resistance of the load is R_{i,0} and reactance of the load is X_{i,0}; resistance per kilometer of a line is r_{i,0}, reactance per kilometer is x_{i,0}, conductance per kilometer of the line is g_{i,0}, susceptance per kilometer of the line is b_{i,0}, and a length of the line is lᵢ; conductance of a transformer is Gt_{i,0}, susceptance of the transformer is Bt_{i,0}, resistance of the transformer is Rt_{i,0}, reactance of the transformer is Xt_{i,0}, the number of primary turns is n_{i,0} and the number of secondary turns is n_{i,0}; and internal resistance of the generator is r_{i,0}′, and reactance of the generator is x_{1,0}′; then the initial matrix of each node is as follows:
an initial matrix of the load is:

$$( \begin{matrix}1 & 0 & 0 \\ \frac{1}{{R}_{i , 0} + {jX}_{i , 0}} & 1 & 0 \\ 0 & 0 & 1\end{matrix} ) ;$$

an initial matrix of the line is:

$$( \begin{matrix}cosh {γ}_{i , 0} {l}_{i} & {Z}_{Ci , 0} sinh {γ}_{i , 0} {l}_{i} & 0 \\ \frac{sinh {γ}_{i , 0} {l}_{i}}{{Z}_{Ci , 0}} & cosh {γ}_{i , 0} {l}_{i} & 0 \\ 0 & 0 & 1\end{matrix} ) , \\ where {z}_{i , 0} = {r}_{i , 0} + j {x}_{i , 0} , \\ {y}_{i , 0} = {g}_{i , 0} + j {b}_{i , 0} , {Z}_{Ci , 0} = \sqrt{\frac{{z}_{i , 0}}{{y}_{i , 0}}} , {γ}_{i , 0} = \sqrt{{z}_{i , 0} {y}_{i , 0}} ;$$

an initial matrix of the transformer is:

$$( \begin{matrix}1 & 0 & 0 \\ G {t}_{i , 0} + jB {t}_{i , 0} & 1 & 0 \\ 0 & 0 & 1\end{matrix} ) ( \begin{matrix}1 & R {t}_{i , 0} + j X {t}_{i , 0} & 0 \\ 0 & 1 & 0 \\ 0 & 0 & 1\end{matrix} ) ( \begin{matrix}\frac{{n}_{i , 1}}{{n}_{i , 2}} & 0 & 0 \\ 0 & \frac{{n}_{i , 2}}{{n}_{i , 1}} & 0 \\ 0 & 0 & 1\end{matrix} ) = ( \begin{matrix}\frac{{n}_{i , 1}}{{n}_{i , 2}} & \frac{{n}_{i , 2}}{{n}_{i , 1}} ( {Rt}_{i , 0} + {jXt}_{i , 0} ) & 0 \\ \frac{{n}_{i , 1}}{{n}_{i , 2}} ( {Gt}_{i , 0} + {jBt}_{i , 0} ) & \frac{{n}_{i , 2}}{{n}_{i , 1}} [ 1 + ( {Gt}_{i , 0} + {jBt}_{i , 0} ) ( {Rt}_{i , 0} + {jXt}_{i , 0} ) ] & 0 \\ 0 & 0 & 1\end{matrix} ) ;$$

an initial matrix of the generator is:

$$( \begin{matrix}1 & 0 & 0 \\ \frac{1}{{r}_{i , 0}^{′} + j {x}_{i , 0}^{′}} & 1 & \frac{{\dot{E}}_{i , 0}}{{r}_{i , 0}^{′} + j {x}_{i , 0}^{′}} \\ 0 & 0 & 1\end{matrix} ) .$$

Further, a specific process of calculating the reactance and susceptance of each node according to f_{W,n+1} in the step H is as follows:
the reactance of the load at the frequency f_{W,n+1} is

$${X}_{i , n + 1} = \frac{{f}_{W , n + 1}}{{f}_{W , 0}} \times {X}_{i , 0} ;$$

the reactance per kilometer of the line at the frequency f_{W,n+1} is

$${x}_{i , n + 1} = \frac{{f}_{W , n + 1}}{{f}_{W , 0}} \times {x}_{i , 0} ,$$

and the susceptance per kilometer of the line is

$${b}_{i , n + 1} = \frac{{f}_{W , n + 1}}{{f}_{W , 0}} \times {b}_{i , 0} ;$$

the reactance of the transformer at the frequency f_{W,n+1} is

$$X {t}_{i , n + 1} = \frac{{f}_{W , n + 1}}{{f}_{W , 0}} \times X {t}_{i , 0} ,$$

and the susceptance of the transformer is

$$B {t}_{i , n + 1} = \frac{{f}_{W , n + 1}}{{f}_{W , 0}} \times B {t}_{i , 0} ;$$

and
the reactance of the generator at the frequency f_{W,n+1} is

$${x}_{i , n + 1}^{′} = \frac{{f}_{W , n + 1}}{{f}_{W , 0}} \times {x}_{i , 0}^{′} .$$

Further, in the step H, the new matrix of each node at the frequency fₙ₊₁ is as follows:
a new matrix of the load is:

$$( \begin{matrix}1 & 0 & 0 \\ \frac{1}{{R}_{i , 0} + j {X}_{i , n + 1}} & 1 & 0 \\ 0 & 0 & 1\end{matrix} ) ;$$

a new matrix of the line is:

$$( \begin{matrix}cosh {γ}_{i , n + 1} {l}_{i} & {Z}_{Ci , n + 1} sinh {γ}_{i , n + 1} {l}_{i} & 0 \\ \frac{sinh {γ}_{i , n + 1} {l}_{i}}{{Z}_{Ci , n + 1}} & cosh {γ}_{i , n + 1} {l}_{i} & 0 \\ 0 & 0 & 1\end{matrix} ) , \\ where {z}_{i , n + 1} = {r}_{i , 0} + {jx}_{i , n + 1} , \\ {y}_{i , n + 1} = {g}_{i , 0} + {jb}_{i , n + 1} , \\ {Z}_{Ci , n + 1} = \sqrt{\frac{{z}_{i , n + 1}}{{y}_{i , n + 1}}} , \\ {γ}_{i , n + 1} = \sqrt{{z}_{i , n + 1} {y}_{i , n + 1}} ;$$

a new matrix of the transformer is:

$$( \begin{matrix}1 & 0 & 0 \\ {Gt}_{i , 0} + j {Bt}_{i , n + 1} & 1 & 0 \\ 0 & 0 & 1\end{matrix} ) ( \begin{matrix}1 & {R}_{i , 0} + j {Xt}_{i , n + 1} & 0 \\ 0 & 1 & 0 \\ 0 & 0 & 1\end{matrix} ) ( \begin{matrix}\frac{{n}_{i , 1}}{{n}_{i , 2}} & 0 & 0 \\ 0 & \frac{{n}_{i , 2}}{{n}_{i , 1}} & 0 \\ 0 & 0 & 1\end{matrix} ) = ( \begin{matrix}\frac{{n}_{i , 1}}{{n}_{i , 2}} & \frac{{n}_{i , 2}}{{n}_{i , 1}} ( {Rt}_{i , 0} + {jXt}_{i , n + 1} ) & 0 \\ \frac{{n}_{i , 1}}{{n}_{i , 2}} ( {Gt}_{i , 0} + {jBt}_{i , n + 1} ) & \frac{{n}_{i , 2}}{{n}_{i , 1}} [ 1 + ( {Gt}_{i , 0} + j {Bt}_{i , n + 1} ) ( {Rt}_{i , 0} + {jXt}_{i , n + 1} ) ] & 0 \\ 0 & 0 & 1\end{matrix} ) ;$$

a new matrix of the generator is:

$$( \begin{matrix}1 & 0 & 0 \\ \frac{1}{{r}_{i , 0}^{′} + j {x}_{i , n + 1}^{′}} & 1 & \frac{{\dot{E}}_{i , n + 1}}{{r}_{i , 0}^{′} + j {x}_{i , n + 1}^{′}} \\ 0 & 0 & 1\end{matrix} ) .$$

Further, when the frequency adjustment is performed in the step C, if the generator is a non-frequency-modulation generator, then T_{i,n+1}=T_{i,n}; and
if the generator is a frequency modulation generator, then:

when f_{i,n+1}>50+Δf_{sqi}, T_{i,n+1}=T_{i,n}−K_{Ti}×[f_{i,n+1}−(50+Δf_{sqi})];

when f_{i,n+1}<50−Δf_{sqi}, T_{i,n+1}=T_{i,n}×K_{Ti}×[(50−Δf_{sqi})−f_{i,n+1}]; and

when f_{i,n+1}≥50−Δf_{sqi} and f_{i,n+1}≤50+Δf_{sqi}, T_{i,n+1}=T_{i,n};
where K_{Ti} is the frequency modulation coefficient, and Δf_{sqi} is the dead zone frequency.

Further, when the excitation adjustment is performed in the step D, the excitation adjustment of the generator can only be one selected from the following four types of adjustment: non-adjustment, voltage adjustment, reactive power adjustment and power factor adjustment:
if the generator does not participate in the excitation adjustment, then I_{Li,n+}=I_{Li,n};
if the generator uses the voltage adjustment, then:

when U_{i,n}>U_{sdi}+ΔU_{sqi}, I_{Li,n+1}=I_{Li,n}−Kᵤᵢ×[U_{i,n}−(U_{sdi}+ΔU_{sqi})];

when U_{i,n}<U_{sdi}−ΔU_{sqi}, I_{Li,n+1}=I_{Li,n}+Kᵤᵢ×[(U_{sdi}−ΔU_{sqi})−U_{i,n}]; and

when U_{i,n}≥U_{sdi}−ΔU_{sqi} and U_{i,n}≤U_{sdi}ΔU_{sqi}, I_{Li,n+1}=I_{Li,n};
if the generator uses the reactive power adjustment, then:

when Q_{i,n}>Q_{sdi}+ΔQ_{sqi}, I_{Li,n+1}=I_{Li,n}−K_{Qi}×[Q_{i,n}−(Q_{sdi}+ΔQ_{sqi})];

when Q_{i,n}<Q_{sdi}−ΔQ_{sqi}, I_{Li,n+1}=I_{Li,n}+K_{Qi}×[(Q_{sdi}−ΔQ_{sqi})−Q_{i,n}]; and

when Q_{i,n}≥Q_{sdi}−ΔQ_{sdi} and Q_{i,n}≤Q_{sdi}+ΔQ_{sqi}, I_{Li,n+1}−I_{Li,n}; and
if the generator uses the power factor adjustment, then:

when COS_{i,n}>COS_{sdi}+ΔCOS_{sqi},

L_{i,n+1}=I_{Li,n}+K_{COSi}×[COS_{i,n}−(COS_{sdi}+ΔCOS_{sqi})];

when COS_{i,n}<COS_{sdi}−ΔCOS_{sqi},

L_{i,n+1}=I_{Li,n}−K_{COSi}×[(COS_{sdi}−ΔCOS_{sqi})−COS_{i,n}]; and

when COS_{i,n}≥COS_{sdi}−ΔCOS_{sqi} and COS_{i,n}≤COS_{sdi}+ΔCOS_{sqi},

I_{Li,n+1}=I_{Li,n};
where Kᵤᵢ is the voltage adjustment coefficient of the generator, U_{sdi} is the set voltage, Δu_{sqi} is the dead zone voltage, U_{i,n} is the port voltage of the i-th node generator in the n-th frame, K_{Qi} is the reactive power adjustment coefficient of the generator, Q_{sdi} is the set reactive power, ΔQ_{sqi} is the dead zone reactive power, Q_{i,n} is the output reactive power of the i-th node generator in the n-th frame, K_{COSi} is the power factor adjustment coefficient of the generator, COS_{sdi} is the set power factor, ΔCOS_{sqi} is the dead zone power factor, and COS_{i,n} is the power factor of the i-th node generator in the n-th frame.

The advantages of the present invention are as follows:

(1) In the simulation method of the present invention, the calculation is based on units of frames, and is repeated frame by frame, the calculation method continuously outputs calculation results at each frame. In view of mathematics, when the angular acceleration of all generators is zero, the power flow is considered to be in a steady state. In engineering applications, when the difference between the calculation results of adjacent two frames is relatively small (except for the arguments of voltage and current), the power flow can be considered to be in a steady state.

(2) The calculation value for each frame is an intermediate value of the electromechanical transient process.

(3) By using this calculation method, the parameters can be modified during the calculation to imitate various disturbances in the power grid, so that the power flow changes. For example, if the Y value of the load is modified, then the impact of the load change on the power grid can be simulated; if n_{i,1} and n_{i,2} of the transformer are modified, then the on-load voltage adjustment of the transformer can be simulated; if the excitation current of the generator is modified, then the grid change process after the generator excitation changes can be simulated; if the kinetic moment of the generator is modified, then the influence of the generator output change on the power grid can be simulated; and if the line is divided in half, the load is inserted in the middle, and let the load Y=0, then it is a normal line, and if the load Y=10000, the line short circuit can be simulated.

(4) The present simulation method overcomes the defects of the traditional simulation methods, has no iteration and has a fast calculation speed, a high precision and a small error, and truly reflects the changing characteristics of the power grid. For example, the impedance of each line, load and transformer changes with the frequency change of the power grid, and the frequency of each generator in the power grid can also dynamically change according to its own law.

### BRIEF DESCRIPTION OF THE DRAWINGS

FIG. 1 is a flowchart of an electromechanical transient simulation method for a power system based on a direct linear algorithm.

### DETAILED DESCRIPTION OF THE EMBODIMENTS

The present invention will be further described hereinafter in conjunction with the drawing and specific embodiments.

### Embodiment

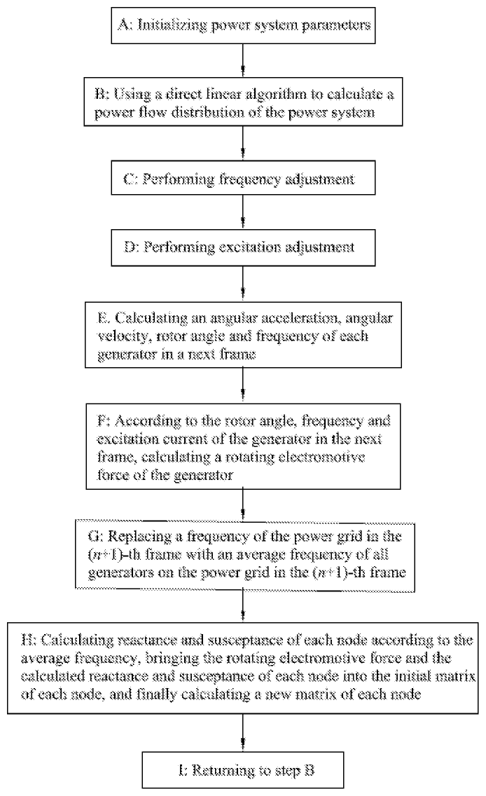

As shown in FIG. 1, the technical solution adopted by the present invention is as follows: an electromechanical transient simulation method for a power system based on a direct linear algorithm, including the following steps:
A. initializing power system parameters and calculating an initial matrix of each node in the power system;
B. using the direct linear algorithm to calculate a power flow distribution of the power system, wherein an output active power of an i-th node generator in a n-th frame is P_{i,n}, an output reactive power is Q_{i,n}, a terminal voltage of the generator is U_{i,n} and a power factor is COS_{i,n}. The direct linear algorithm for calculating the power flow distribution of the power system belongs to the prior art, and please refer to the applicant's patent CN201410142938.7 and patent application CN201610783305.3;
C. performing frequency adjustment to adjust a kinetic moment T_{i,n+1} of the i-th node generator in a (n+1)-th frame;
D. performing excitation adjustment to adjust an excitation current I_{Li,n+1} of the i-th node generator in the (n+1)-th frame;
E. calculating an angular acceleration a_{ω}_{_{i,n+1}}, an angular velocity ω_{i,n+1}, a rotor angle θ_{i,n+1} and a frequency f_{i,n+1} of the i-th node generator in the (n+1)-th frame:

$$\{ \begin{matrix}{a}_{{ω}_{i , n + 1}} = \frac{{T}_{i , n + 1} - \frac{{P}_{i , n}}{{ω}_{i , n}}}{{J}_{i}} \\ {ω}_{i , n + 1} = {ω}_{i , n} + {a}_{{ω}_{i , n + 1}} \times Δ T \\ {θ}_{i , n + 1} = {θ}_{i , n} + {ω}_{i , n + 1} \times Δ T \\ {f}_{i , n + 1} = \frac{{ω}_{i , n + 1}}{2 π}\end{matrix}$$

wherein Jᵢ is a rotating inertia of the i-th node generator, ΔT is a frame calculation time interval, n is a frame number, and an initial value of n is 0;
F. according to the rotor angle θ_{i,n+1}, the frequency f_{i,n+1} and the excitation current I_{Li,n+1} of the generator in the (n+1)-th frame, calculating a rotating electromotive force of the generator in the (n+1)-th frame, wherein
an absolute value of the rotating electromotive force of the generator is |E_{i,n+1}|=K_{Li}×I_{Li,n+1}×f_{i,n+1}, and then a vector value of the rotating electromotive force is Ė_{i,n+1}=|E_{i,n+1}|×e^{θ}^{_{i,n+1}}, where K_{Li} is an electromotive force coefficient of the i-th node generator;
G replacing a frequency of the power grid in the (n+1)-th frame with an average frequency

$${f}_{W , n + 1} = \frac{1}{m} \sum {f}_{i , n + 1}$$

(where m is a total number of generators in the power system) of all generators on the power grid in the (n+1)-th frame;
H. calculating reactance and susceptance of each node according to f_{W,n+1}, bringing Ė_{i,n+1} and the calculated reactance and susceptance of each node into the initial matrix of each node, and finally calculating a new matrix of each node; and
I. returning to step B.

In another embodiment, the initializing power system parameters in the step A specifically includes the following processes:
A1. setting the frame calculation time interval ΔT;
A2. setting an initial frequency f_{i,0}=50 Hz, an initial angular acceleration a_{ω}_{_{i,0}}=0, an initial angle θ_{i,0}=0, and an initial angular velocity ω_{i,0}=2×π×f_{i,0} of each generator;
A3. setting the excitation current I_{Li,0} of each generator to a rated value and setting an excitation coefficient K_{Li} of each generator, wherein an initial value of the rotating electromotive force of each generator is Ė_{i,0}=K_{Li}×I_{Li,0}×f_{i,0}×e^{jθ};
A4. setting an initial value of a system frequency on the grid to f_{W,0}=50 Hz, determining the reactance and susceptance of each node according to f_{W,0}, and finally calculating the initial matrices of all nodes;
A5. setting a kinetic moment of a grid-connected generator, or sharing a load of the whole grid according to a capacity ratio of the grid-connected generator, and determining the kinetic moment

$${T}_{i , 1} = {T}_{i , 0} = \frac{{P}_{i , 0}}{{ω}_{i , 0}}$$

of each generator in a first frame and a starting frame;
A6. setting a frequency modulation coefficient K_{Ti} and a dead zone frequency Δf_{sqi} of a frequency modulation generator;
A7. setting a voltage adjustment coefficient Kᵤᵢ, a set voltage U_{sdi} and a dead zone voltage ΔU_{sqi} of a voltage adjustment generator;
A8. setting a reactive power adjustment coefficient K_{Qi}, a set reactive power Q_{sdi} and a dead zone reactive power ΔQ_{sqi} of the reactive power generator; and
A9. setting a power factor adjustment coefficient K_{cosi}, a set power factor COS_{sdi} and a dead zone power factor ΔCOS_{sqi} of the power factor adjustment generator.

In another embodiment, the step A4 specifically includes the following processes: assuming that in the power system, at an initial frequency f_{W,0}=50 Hz, resistance of the load is R_{i,0} and reactance of the load is X_{i,0}; resistance per kilometer of a line is r_{i,0}, reactance per kilometer of the line is x_{i,0}, conductance per kilometer of the line is g_{i,0}, susceptance per kilometer of the line is b_{i,0}, and a length of the line is lᵢ; conductance of a transformer is Gt_{i,0}, susceptance of the transformer is Bt_{i,0}, resistance of the transformer is Rt_{i,0}, reactance of the transformer is Xt_{i,0}, the number of primary turns of the transformer is n_{i,1} and the number of secondary turns of the transformer is n_{i,2}; and internal resistance of the generator is r_{i,0}′, and reactance of the generator is x_{i,0}′; then the initial matrix of each node is as follows:
an initial matrix of the load is:

$$( \begin{matrix}1 & 0 & 0 \\ \frac{1}{{R}_{i , 0} + j {X}_{i , 0}} & 1 & 0 \\ 0 & 0 & 1\end{matrix} ) ;$$

an initial matrix of the line is:

$$( \begin{matrix}cosh {γ}_{i , 0} {l}_{i} & {Z}_{Ci , 0} sinh {γ}_{i , 0} {l}_{i} & 0 \\ \frac{sinh {γ}_{i , 0} {l}_{i}}{{Z}_{Ci , 0}} & cosh {γ}_{i , 0} {l}_{i} & 0 \\ 0 & 0 & 1\end{matrix} ) , \\ where {z}_{i , 0} = {r}_{i , 0} + {jx}_{i , 0} , \\ {y}_{i , 0} = {g}_{i , 0} + {jb}_{i , 0} , {Z}_{Ci , 0} = \sqrt{\frac{{z}_{i , 0}}{{y}_{i , 0}}} , {γ}_{i , 0} = \sqrt{{z}_{i , 0} {y}_{i , 0}} ;$$

an initial matrix of the transformer is:

$$( \begin{matrix}1 & 0 & 0 \\ {Gt}_{i , 0} + {jBt}_{i , 0} & 1 & 0 \\ 0 & 0 & 1\end{matrix} ) ( \begin{matrix}1 & {Rt}_{i , 0} + {jXt}_{i , 0} & 0 \\ 0 & 1 & 0 \\ 0 & 0 & 1\end{matrix} ) ( \begin{matrix}\frac{{n}_{i , 1}}{{n}_{i , 2}} & 0 & 0 \\ 0 & \frac{{n}_{i , 2}}{{n}_{i , 1}} & 0 \\ 0 & 0 & 1\end{matrix} ) = ( \begin{matrix}\frac{{n}_{i , 1}}{{n}_{i , 2}} & \frac{{n}_{i , 2}}{{n}_{i , 1}} ( {Rt}_{i , 0} + {jXt}_{i , 0} ) & 0 \\ \frac{{n}_{i , 1}}{{n}_{i , 2}} {Gt}_{i , 0} + {jBt}_{i , 0} & \frac{{n}_{i , 2}}{{n}_{i , 1}} [ 1 + ( {Gt}_{i , 0} + {jBt}_{i , 0} ) ( {Rt}_{i , 0} + {jXt}_{i , 0} ) ] & 0 \\ 0 & 0 & 1\end{matrix} ) ;$$

an initial matrix of the generator is:

$$( \begin{matrix}1 & 0 & 0 \\ \frac{1}{{r}_{i , 0}^{′} + {jx}_{i , 0}^{′}} & 1 & - \frac{{\dot{E}}_{i , 0}}{{r}_{i , 0}^{′} + {jx}_{i , 0}^{′}} \\ 0 & 0 & 1\end{matrix} ) ;$$

when the initial frequency f_{W,0}=50 Hz, the values of R_{i,0}, X_{i,0}, r_{i,0}, x_{i,0}, g_{i,0}, b_{i,0}, Gt_{i,0}, Bt_{i,0}, Rt_{i,0}, Xt_{i,0}, r_{i,0}′, and x_{i,0}′ can be determined, which are known conditions, and the specific values are brought into the corresponding initial matrices.

In another embodiment, a specific process of calculating the reactance and susceptance of each node according to f_{W,n+1} in the step H is as follows:
the reactance of the load at the frequency f_{W,n+1} is

$${X}_{i , n + 1} = \frac{{f}_{W , n + 1}}{{f}_{W , 0}} \times {X}_{i , 0} ;$$

the reactance per kilometer of the line at the frequency f_{W,n+1} is

$${x}_{i , n + 1} = \frac{{f}_{W , n + 1}}{{f}_{W , 0}} \times {x}_{i , 0} ,$$

and the susceptance per kilometer of the line is

$${b}_{i , n + 1} = \frac{{f}_{W , n + 1}}{{f}_{W , 0}} \times {b}_{i , 0} ;$$

the reactance of the transformer at the frequency f_{W,n+1} is

$${Xt}_{i , n + 1} = \frac{{f}_{W , n + 1}}{{f}_{W , 0}} \times {Xt}_{i , 0} ,$$

and the susceptance of the transformer is

$${Bt}_{i , n + 1} = \frac{{f}_{W , n + 1}}{{f}_{W , 0}} \times {Bt}_{i , 0} ;$$

and
the reactance of the generator at the frequency f_{W,n+1} is

$${x}_{i , n + 1}^{′} = \frac{{f}_{W , n + 1}}{{f}_{W , 0}} \times {x}_{ι , 0}^{′} .$$

In another embodiment, in the step H, the new matrix of each node at the frequency f_{W,n+1} is as follows:
a new matrix of the load is:

$$( \begin{matrix}1 & 0 & 0 \\ \frac{1}{{R}_{i , 0} + j \frac{{f}_{W , n + 1}}{50} \times {X}_{i , 0}} & 1 & 0 \\ 0 & 0 & 1\end{matrix} ) ;$$

a new matrix of the line is:

$$( \begin{matrix}cosh {γ}_{i , n + 1} {l}_{i} & {Z}_{Ci , n + 1} sinh {γ}_{i , n + 1} {l}_{i} & 0 \\ \frac{sinh {γ}_{i , n + 1} {l}_{i}}{{Z}_{Ci , n + 1}} & cosh {γ}_{i , n + 1} {l}_{i} & 0 \\ 0 & 0 & 1\end{matrix} ) , \\ where {z}_{i , n + 1} = {r}_{i , 0} + {jx}_{i , n + 1} = {r}_{i , 0} + j \frac{{f}_{W , n + 1}}{50} \times {x}_{i , 0} , \\ {y}_{i , n + 1} = {g}_{i , 0} + {jb}_{i , n + 1} = {g}_{i , 0} + j \frac{{f}_{W , n + 1}}{50} \times {b}_{i , 0}$$

$${Z}_{Ci , n + 1} = \sqrt{\frac{{z}_{i , n + 1}}{{y}_{i , n + 1}}} , {γ}_{i , n + 1} = \sqrt{{z}_{i , n + 1} {y}_{i , n + 1}}$$

a new matrix of the transformer is:

$$( \begin{matrix}1 & 0 & 0 \\ {Gt}_{i , 0} + j \frac{{f}_{W , n + 1}}{50} \times {Bt}_{i , 0} & 1 & 0 \\ 0 & 0 & 1\end{matrix} ) ( \begin{matrix}1 & {Rt}_{i , 0} + j \frac{{f}_{W , n + 1}}{50} \times {Xt}_{i , 0} & 0 \\ 0 & 1 & 0 \\ 0 & 0 & 1\end{matrix} ) ( \begin{matrix}\frac{{n}_{i , 1}}{{n}_{i , 2}} & 0 & 0 \\ 0 & \frac{{n}_{i , 2}}{{n}_{i , 1}} & 0 \\ 0 & 0 & 1\end{matrix} ) = ( \begin{matrix}\frac{{n}_{i , 1}}{{n}_{i , 2}} & \frac{{n}_{i , 2}}{{n}_{i , 1}} ( {Rt}_{i , 0} + j \frac{{f}_{W , n + 1}}{50} \times {Xt}_{i , 0} ) & 0 \\ \frac{{n}_{i , 1}}{{n}_{i , 2}} {Gt}_{i , 0} + j \frac{{f}_{W , n + 1}}{50} \times {Bt}_{i , 0} & \frac{{n}_{i , 2}}{{n}_{i , 1}} [ 1 + ( {Gt}_{i , 0} + j \frac{{f}_{W , n + 1}}{50} \times {Bt}_{i , 0} ) ( {Rt}_{i , 0} + j \frac{{f}_{W , n + 1}}{50} \times {Xt}_{i , 0} ) ] & 0 \\ 0 & 0 & 1\end{matrix} )$$

a new matrix of the generator is:

$$( \begin{matrix}1 & 0 & 0 \\ \frac{1}{{r}_{i , 0}^{′} + j \frac{{f}_{W , n + 1}}{50} \times {x}_{i , 0}^{′}} & 1 & - \frac{{\dot{E}}_{i , n + 1}}{{r}_{i , 0}^{′} + j \frac{{f}_{W , n + 1}}{50} \times {x}_{i , 0}^{′}} \\ 0 & 0 & 1\end{matrix} ) .$$

In another embodiment, when the frequency adjustment is performed in the step C,
if the generator is a non-frequency-modulation generator, then T_{i,n+1}=T_{i,n}; and
if the generator is a frequency modulation generator, then:

when f_{i,n+1}>50+Δf_{sqi}, T_{i,n+1}=T_{i,n}−K_{Ti}×[f_{i,n+1}−(50+Δf_{i,n+1}];

when f_{i,n+1}<50−Δf_{sqi}, T_{i,n+1}=T_{i,n}+K_{Ti}×[(50−Δf_{sqi})−f_{i,n+1}]; and

when f_{i,n+1}≥50−Δf_{sqi} and f_{i,n+1}≤50+Δf_{sqi},T_{i,n+1}=T_{i,n};
where K_{Ti} is the frequency modulation coefficient, and Δf_{sqi} is the dead zone frequency.

In another embodiment, when the excitation adjustment is performed in the step D, the excitation adjustment of the generator can only be one selected from the following four types of adjustment: non-adjustment, voltage adjustment, reactive power adjustment and power factor adjustment:
if the generator does not participate in the excitation adjustment, then I_{Li,n+1}=I_{Li,n};
if the generator uses the voltage adjustment, then:

when U_{i,n}>U_{sdi}+ΔU_{sqi}, I_{Li,n+1}=I_{Li,n}−Kᵤᵢ×[U_{i,n}−(U_{sdi}+ΔU_{sqi})];

when U_{i,n}<U_{sdi}−ΔU_{sqi}, I_{Li,n+1}=I_{Li,n}+Kᵤᵢ×[(U_{sdi}−ΔU_{sqi})−U_{i,n}]; and

when U_{i,n}≥U_{sdi}−ΔU_{sqi} and U_{i,n}≤U_{sdi}+ΔU_{sqi}, I_{Li,n+1}=I_{Li,n};
if the generator uses the reactive power adjustment, then:

when Q_{i,n}>Q_{sdi}+ΔQ_{sqi}, I_{Li,n+1}=I_{Li,n}−K_{Qi}×[U_{i,n}−(Q_{i,n}−(Q_{sdi}+ΔQ_{sqi})];

when Q_{i,n}<Q_{sdi}ΔQ_{sqi}, I_{Li,n+1}=I_{Li,n}+K_{Qi}×[(Q_{sdi}−ΔQ_{sqi})−Q_{i,n}]; and

when Q_{i,n}≤Q_{sdi}−ΔQ_{sqi} and Q_{i,n}≤Q_{sdi}+ΔQ_{sqi}, I_{Li,n+1}=I_{Li,n}; and
if the generator uses the power factor adjustment, then:

when COS_{i,n}>COS_{sdi}+ΔCOS_{sqi},

I_{Li,n+1}=I_{Li,n}+K_{COSi}×[COS_{i,n}−(COS_{sdi}+ΔCOS_{sqi})];

when COS_{i,n}<COS_{sdi}−ΔCOS_{sqi},

I_{Li,n+1}=I_{Li,n}−K_{COSi}×[(COS_{sdi}−ΔCOS_{sqi})−COS_{i,n}]; and

when COS_{i,n}≥COS_{sdi}−ΔCOS_{sqi} and COS_{i,n}≤COS_{sdi}+ΔCOS_{sqi},

I_{Li,n+1}=I_{Li,n};
where Kᵤᵢ is the voltage adjustment coefficient of the generator, U_{sdi} is the set voltage, ΔU_{sqi} is the dead zone voltage, U_{i,n} is the port voltage of the i-th node generator in the n-th frame, K_{Qi} is the reactive power adjustment coefficient of the generator, Q_{sdi} is the set reactive power, ΔQ_{sqi} is the dead zone reactive power, Q_{i,n} is the output reactive power of the i-th node generator in the n-th frame, K_{COSi} is the power factor adjustment coefficient of the generator, COS_{sdi} is the set power factor, ΔCOS_{sqi} is the dead zone power factor, and COS_{i,n} is the power factor of the i-th node generator in the n-th frame.

The present invention is not limited to optional embodiments described above, so that anyone can derive other various forms of products under the inspiration of the present invention. The above specific embodiments should not be construed as limiting the scope of protection of the present invention. The scope of protection of the present invention should be as defined in the claims, and the description can be used to interpret the claims.

What is claimed is:

1. An electromechanical transient simulation method for a power system based on a direct linear algorithm, comprising the following steps:
A: initializing power system parameters and calculating an initial matrix of each node of a plurality of nodes in the power system;
B: calculating a power flow distribution of the power system by using the direct linear algorithm, wherein
an output active power of an i-th node generator in a n-th frame is P_{i,n},
an output reactive power of the i-th node generator in the n-th frame is Q_{i,n},
a terminal voltage of the i-th node generator in the n-th frame is U_{i,n} and
a power factor of the i-th node generator in the n-th frame is COS_{i,n};
C: performing frequency adjustment to adjust a kinetic moment T_{i,n+1} of the i-th node generator in a (n+1)-th frame;
D: performing excitation adjustment to adjust an excitation current I_{Li,n+1} of the i-th node generator in the (n+1)-th frame;
E: calculating an angular acceleration a_{ω}_{_{i,n+1}}, an angular velocity ω_{i,n+1}, a rotor angle θ_{i,n+}, and a frequency f_{i,n+1} of the i-th node generator in the (n+1)-th frame:
$$\{ \begin{matrix}{a}_{{ω}_{n + 1}} = \frac{{T}_{i , n + 1} - \frac{{P}_{i , n}}{{ω}_{i , n}}}{{J}_{i}} \\ {ω}_{i , n + 1} = {ω}_{i , n} + {a}_{{ω}_{n + 1}} \times Δ T \\ {θ}_{i , n + 1} = {θ}_{i , n} + {ω}_{i , n + 1} \times Δ T \\ {f}_{i , n + 1} = \frac{{ω}_{i , n + 1}}{2 π}\end{matrix}$$
wherein Jᵢ is a rotating inertia of the i-th node generator, ΔT is a frame calculation time interval, n is a frame number, and an initial value of n is 0;
F: calculating a rotating electromotive force of the i-th node generator in the (n+1)-th frame according to the rotor angle θ_{i,n+1}, the frequency f_{i,n+1} and the excitation current I_{Li,n+1} of the i-th node generator in the (n+1)-th frame, wherein
an absolute value of the rotating electromotive force of the i-th node generator is |E_{i,n+1}|=K_{Li}×I_{Li,n+1}×f_{i,n+1}, and then a vector value of the rotating electromotive force is Ė_{i,n+1}=|E_{i,n+1}|×e^{θ}^{_{i,n+1}}, where K_{Li} is an electromotive force coefficient of the i-th node generator;
G: replacing a frequency of a power grid in (n+1)-th frame with an average frequency
$${f}_{W , n + 1} = \frac{1}{m} \sum {f}_{i , n + 1}$$
of a plurality of generators on the power grid in the (n+1)-th frame, where m is a total number of the plurality of generators in the power system;
H: calculating reactance and susceptance of the each node according to f_{W,n+1}, bringing Ė_{i,n+1} and the reactance and the susceptance of the each node into the initial matrix of the each node, and finally calculating a new matrix of the each node; and
I: returning to step B.

2. The electromechanical transient simulation method according to claim 1, wherein the step of initializing the power system parameters in the step A specifically comprises the following processes:
A1: setting the frame calculation time interval ΔT;
A2: setting an initial frequency f_{i,0}=50 Hz, an initial angular acceleration a_{ω}_{_{i,0}}=0, an initial angle θ_{i,0}=0, and an initial angular velocity ω_{i,0}=2×π×f_{i,0} of each generator of the plurality of generator;
A3: setting the excitation current I_{Li,0} of the each generator to a rated value and setting an excitation coefficient K_{Li} of the each generator, wherein an initial value of the rotating electromotive force of the each generator is Ė_{i,0}=K_{Li}×I_{Li,0}×f_{i,0}×e^{jθ};
A4: setting an initial value of a system frequency on the grid to f_{W,0}=50 Hz, determining the reactance and the susceptance of the each node according to f_{W,0}, and finally calculating the initial matrices of the plurality of nodes;
A5: setting a kinetic moment of a grid-connected generator, or sharing a load of the whole grid according to a capacity ratio of the grid-connected generator, and determining the kinetic moment
$${T}_{i , 1} = {T}_{i , 0} = \frac{{P}_{i , 0}}{{ω}_{i , 0}}$$
of the each generator in a first frame and a starting frame;
A6: setting a frequency modulation coefficient K_{Ti} and a dead zone frequency Δf_{sqi} of a frequency modulation generator;
A7: setting a voltage adjustment coefficient Kᵤᵢ, a set voltage U_{sdi} and a dead zone voltage ΔU_{sqi} of a voltage adjustment generator;
A8: setting a reactive power adjustment coefficient K_{Qi}, a set reactive power Q_{sdi} and a dead zone reactive power ΔQ_{sqi} of a reactive power generator; and
A9: setting a power factor adjustment coefficient K_{cosi}, a set power factor COS_{sdi} and a dead zone power factor ΔCOS_{sqi} of a power factor adjustment generator.

3. The electromechanical transient simulation method according to claim 2, wherein the step A4 specifically comprises the following processes:
assuming that in the power system, at an initial frequency f_{W,0}=50 Hz, resistance of the load is R_{i,0} and reactance of the load is X_{i,0};
resistance per kilometer of a line is r_{i,0}, reactance per kilometer of the line is x_{i,0}, conductance per kilometer of the line is g_{i,0}, susceptance per kilometer of the line is b_{i,0}, and a length of the line is lᵢ;
conductance of a transformer is Gt_{i,0}, susceptance of the transformer is Bt_{i,0}, resistance of the transformer is Rt_{i,0}, reactance of the transformer is Xt_{i,0}, the number of primary turns of the transformer is n_{i,1} and the number of secondary turns of the transformer is n_{i,2}; and
internal resistance of the i-th node generator is r_{i,0}′, and reactance of the i-th node generator is x_{i,0}′;
then the initial matrix of the each node is as follows:
an initial matrix of the load is:
$$( \begin{matrix}1 & 0 & 0 \\ \frac{1}{{R}_{i , 0} + {jX}_{i , 0}} & 1 & 0 \\ 0 & 0 & 1\end{matrix} ) ;$$
an initial matrix of the line is:
$$( \begin{matrix}cosh {γ}_{i , 0} {l}_{i} & {Z}_{Ci , 0} sinh {γ}_{i , 0} {l}_{i} & 0 \\ \frac{sinh {γ}_{i , 0} {l}_{i}}{{Z}_{Ci , 0}} & cosh {γ}_{i , 0} {l}_{i} & 0 \\ 0 & 0 & 1\end{matrix} ) , where$$
$${z}_{i , 0} = {r}_{i , 0} + {jx}_{i , 0} , {y}_{i , 0} = {g}_{i , 0} + {jb}_{i , 0} , {Z}_{Ci , 0} = \sqrt{\frac{{z}_{i , 0}}{{y}_{i , 0}}} , {γ}_{i , 0} = \sqrt{{z}_{i , 0} {y}_{i , 0}} ;$$
an initial matrix of the transformer is:
$$( \begin{matrix}1 & 0 & 0 \\ {Gt}_{i , 0} + {jB}_{i , 0} & 1 & 0 \\ 0 & 0 & 1\end{matrix} ) ( \begin{matrix}1 & {Rt}_{i , 0} + {jXt}_{i , 0} & 0 \\ 0 & 1 & 0 \\ 0 & 0 & 1\end{matrix} ) ( \begin{matrix}\frac{{n}_{i , 1}}{{n}_{i , 2}} & 0 & 0 \\ 0 & \frac{{n}_{i , 2}}{{n}_{i , 1}} & 0 \\ 0 & 0 & 1\end{matrix} ) = ( \begin{matrix}\frac{{n}_{i , 1}}{{n}_{i , 2}} & \frac{{n}_{i , 2}}{{n}_{i , 1}} ( {Rt}_{i , 0} + {jXt}_{i , 0} ) & 0 \\ \frac{{n}_{i , 1}}{{n}_{i , 2}} ( {Gt}_{i , 0} + {jBt}_{i , 0} ) & \frac{{n}_{i , 2}}{{n}_{i , 1}} [ \begin{matrix}1 + ( {Gt}_{i , 0} + {jBt}_{i , 0} ) \\ ( {Rt}_{i , 0} + {jXt}_{i , 0} )\end{matrix} ] & 0 \\ 0 & 0 & 1\end{matrix} ) ;$$
an initial matrix of the i-th node generator is:
$$( \begin{matrix}1 & 0 & 0 \\ \frac{1}{{r}_{i , 0}^{′} + {jX}_{i , 0}^{′}} & 1 & - \frac{{\dot{E}}_{i , 0}}{{r}_{i , 0}^{′} + {jX}_{i , 0}^{′}} \\ 0 & 0 & 1\end{matrix} ) .$$

4. The electromechanical transient simulation method according to claim 3, wherein a specific process of calculating the reactance and susceptance of each node according to f_{W,n+1} in the step H is as follows:
the reactance of the load at the frequency f_{W,n+1} is
$${X}_{i , n + 1} = \frac{{f}_{W , n + 1}}{{f}_{W , 0}} \times {X}_{i , 0} ;$$
the reactance per kilometer of the line at the frequency f_{W,n+1} is
$${x}_{i , n + 1} = \frac{{f}_{W , n + 1}}{{f}_{W , 0}} \times {x}_{i , 0} ,$$
and the susceptance per kilometer of the line at the frequency f_{W,n+1} is
$${b}_{i , n + 1} = \frac{{f}_{W , n + 1}}{{f}_{W , 0}} \times {b}_{i , 0} ;$$
the reactance of the transformer at the frequency f_{W,n+1} is
$$X {t}_{i , n + 1} = \frac{{f}_{W , n + 1}}{{f}_{W , 0}} \times {Xt}_{i , 0} ,$$
and the susceptance of the transformer at the frequency f_{W,n+1} is
$${Bt}_{i , n + 1} = \frac{{f}_{W , n + 1}}{{f}_{W , 0}} \times {Bt}_{i , 0} ;$$
and
the reactance of the generator at the frequency f_{W,n+1} is
$${x}_{i , n + 1}^{′} = \frac{{f}_{W , n + 1}}{{f}_{W , 0}} \times {x}_{i , 0}^{′} .$$

5. The electromechanical transient simulation method according to claim 4, wherein in the step H, the new matrix of the each node at the frequency f_{W,n+1} is as follows:
a new matrix of the load is:
$$( \begin{matrix}1 & 0 & 0 \\ \frac{1}{{R}_{i , 0} + {jX}_{i , n + 1}} & 1 & 0 \\ 0 & 0 & 1\end{matrix} ) ;$$
a new matrix of the line is:
$$( \begin{matrix}cosh {γ}_{i , n + 1} {l}_{i} & {Z}_{Ci , n + 1} sinh {γ}_{i , n + 1} {l}_{i} & 0 \\ \frac{sinh {γ}_{i , n + 1} {l}_{i}}{{Z}_{Ci , n + 1}} & cosh {γ}_{i , n + 1} {l}_{i} & 0 \\ 0 & 0 & 1\end{matrix} ) , where$$
$${z}_{i , n + 1} = {r}_{i , 0} + {jx}_{i , n + 1} , {y}_{i , n + 1} = {g}_{i , 0} + {jb}_{i , n + 1} , {Z}_{Ci , n + 1} = \sqrt{\frac{{z}_{i , n + 1}}{{y}_{i , n + 1}}} , {γ}_{i , n + 1} = \sqrt{{z}_{i , n + 1} {y}_{i , n + 1}} ;$$
a new matrix of the transformer is:
$$( \begin{matrix}1 & 0 & 0 \\ {Gt}_{i , 0} + {jB}_{i , n + 1} & 1 & 0 \\ 0 & 0 & 1\end{matrix} ) ( \begin{matrix}1 & {Rt}_{i , 0} + {jXt}_{i , n + 1} & 0 \\ 0 & 1 & 0 \\ 0 & 0 & 1\end{matrix} ) ( \begin{matrix}\frac{{n}_{i , 1}}{{n}_{i , 2}} & 0 & 0 \\ 0 & \frac{{n}_{i , 2}}{{n}_{i , 1}} & 0 \\ 0 & 0 & 1\end{matrix} ) = ( \begin{matrix}\frac{{n}_{i , 1}}{{n}_{i , 2}} & \frac{{n}_{i , 2}}{{n}_{i , 1}} ( {Rt}_{i , 0} + {jXt}_{i , n + 1} ) & 0 \\ \frac{{n}_{i , 1}}{{n}_{i , 2}} ( {Gt}_{i , 0} + {jBt}_{i , n + 1} ) & \frac{{n}_{i , 2}}{{n}_{i , 1}} [ \begin{matrix}1 + ( {Gt}_{i , 0} + {jBt}_{i , n + 1} ) \\ ( {Rt}_{i , 0} + {jXt}_{i , n + 1} )\end{matrix} ] & 0 \\ 0 & 0 & 1\end{matrix} ) ;$$
a new matrix of the generator is:
$$( \begin{matrix}1 & 0 & 0 \\ \frac{1}{{r}_{i , 0}^{′} + {jX}_{i , n + 1}^{′}} & 1 & - \frac{{\dot{E}}_{i , n + 1}}{{r}_{i , 0}^{′} + {jX}_{i , n + 1}^{′}} \\ 0 & 0 & 1\end{matrix} ) .$$

6. The electromechanical transient simulation method according to claim 2, wherein when the frequency adjustment is performed in the step C,
if the i-th node generator is a non-frequency-modulation generator, then T_{i,n+1}=T_{i,n}; and
if the i-th node generator is the frequency modulation generator, then:
when f_{i,n+1}>50+Δf_{sqi}, T_{i,n+1}=T_{i,n}−K_{Ti}×[f_{i,n+1}−(50+Δf_{sqi})];
when f_{i,n+1}<50−Δf_{sqi}, T_{i,n+1}=T_{i,n}+K_{Ti}×[(50−Δf_{sqi})−f_{i,n+1}]; and
when f_{i,n+1}<50−Δf_{sqi} and f_{i,n+1}≤50−Δf_{sqi}, T_{i,n+1}=T_{i,n};
where K_{Ti} is the frequency modulation coefficient, and Δf_{sqi} is the dead zone frequency.

7. The electromechanical transient simulation method according to claim 2, wherein when the excitation adjustment is performed in the step D, the excitation adjustment of the i-th node generator is one selected from the group consisting of non-adjustment, voltage adjustment, reactive power adjustment and power factor adjustment;
when the excitation adjustment is not performed, I_{Li,n+1}=I_{Li,n};
if the i-th node generator uses the voltage adjustment, then:
when U_{i,n}>U_{sdi}+ΔU_{sqi}, I_{Li,n+1}=I_{Li,n}−Kᵤᵢ×[U_{i,n}−(U_{sdi}+ΔU_{sqi})];
when U_{i,n}<U_{sdi}−ΔU_{sqi}, I_{Li,n+1}=I_{Li,n}+Kᵤᵢ×[(U_{sdi}−ΔU_{sqi})−U_{i,u}]; and
when U_{i,n}≥U_{sdi}−ΔU_{sqi} and U_{i,n}≤U_{sdi}+ΔU_{sqi}, I_{Li,n+1}=I_{Li,n};
if the i-th node generator uses the reactive power adjustment, then:
when Q_{i,n}>Q_{sdi}+ΔQ_{sqi}, I_{Li,n+1}=I_{Li,n}−K_{Qi}×[Q_{i,n}−(Q_{sdi}+ΔQ_{sqi})];
when Q_{i,n}<Q_{sdi}−ΔQ_{sqi}, I_{Li,n+1}=I_{Li,n}+K_{Qi}×[(Q_{sdi}−ΔQ_{sqi})−Q_{i,n}]; and
when Q_{i,n}≥Q_{sdi}−ΔQ_{sqi} and Q_{i,n}≤Q_{sdi}+ΔQ_{sqi}, I_{Li,n+1}=I_{Li,n}; and
if the i-th node generator uses the power factor adjustment, then:
when COS_{i,n}>COS_{sdi}+ΔCOS_{sqi},
I_{Li,n+1}=I_{Li,n}+K_{COSi}×[COS_{i,n}−(COS_{sdi}+ΔCOS_{sqi})];
when COS_{i,n}<COS_{sdi}−ΔCOS_{sqi},
I_{Li,n}=I_{Li,n}−K_{COSi}×[(COS_{sdi}−ΔCOS_{sqi})−COS_{i,n}]; and
when COS_{i,n}≥COS_{sdi}−ΔCOS_{sqi} and COS_{i,n}≤COS_{sdi}+ΔCOS_{sqi},
I_{Li,n+1}=I_{Li,n};
where Kᵤᵢ is the voltage adjustment coefficient of the i-th node generator, U_{sdi} is the set voltage, ΔU_{sqi} is the dead zone voltage, U_{i,n} is the port voltage of the i-th node generator in the n-th frame, K_{Qi} is the reactive power adjustment coefficient of the i-th node generator, Q_{sdi} is the set reactive power, ΔQ_{sqi} is the dead zone reactive power, Q_{i,n} is the output reactive power of the i-th node generator in the n-th frame, K_{COSi} is the power factor adjustment coefficient of the i-th node generator, COS_{sdi} is the set power factor, ΔCOS_{sqi} is the dead zone power factor, and COS_{i,n} is the power factor of the i-th node generator in the n-th frame.
